(19) United States
(12) Patent Application Publication
(10) Pub. No.: US 2014/0116149 A1
(43) Pub. Date: May 1, 2014

(54) Sensor with masking

(71) Applicant: Infineon Technologies AG, Neubiberg (DE)

(72) Inventors: Walter DIEZ, Regenstauf (DE); Franz-Peter KALZ, Regensburg (DE); Bernhard WINKLER, Regensburg (DE)

(73) Assignee: Infineon Technologies AG, Neubiberg (DE)

(21) Appl. No.: 14/066,902

(22) Filed: Oct. 30, 2013

(30) Foreign Application Priority Data
Oct. 30, 2012 (DE) 10 2012 021 413.8

(51) Int. Cl. G01L 19/04

(52) U.S. Cl. CPC G01L 19/04
USPC 73/708

(57) ABSTRACT

A sensor may include a sensor membrane, wherein one side of the sensor membrane at least partly has a glob top and wherein the glob top furthermore has structurings.

### CROSS-REFERENCE TO RELATED APPLICATION

This application claims priority to German Patent Application Serial No. 10 2012 021 413.8, which was filed Oct. 30, 2012, and is incorporated herein by reference in its entirety.

### TECHNICAL FIELD

Various embodiments relate to a pressure sensor.

### BACKGROUND

Pressure sensors are used in many contexts, for example in automobiles, in industry, medicine, aviation and in consumer electronics. By way of example, pressure sensors are used in connection with automobiles to measure air pressure and vacuum of intake manifolds, and they can also be used in the context of the use of airbags and other applications.

Conventional pressure sensors are packaged in integrated circuit packages (IC packages, IC=integrated circuit). However, some conventional IC packages expose their pressure sensors to the surrounding environment (e.g. to the air and/or temperature), such that the sensor can measure the ambient pressure. Problems can disadvantageously occur, however, if the pressure sensor is exposed to temperature fluctuations, since, as a result, the measured ambient pressure can be corrupted in some instances to a great extent.

### SUMMARY

Various embodiments provide a pressure sensor which accurately determines an ambient pressure even in the event of temperature fluctuations.

In one embodiment, the sensor includes a sensor membrane, wherein one side of the sensor membrane at least partly has a glob top and wherein the glob top has structurings. By virtue of the structuring of the glob top, the temperature influence on the sensor is greatly reduced and can thus be determined and reproduced significantly more accurately.

In one embodiment, the glob top of the sensor has structurings, wherein the structurings of the glob top are embodied in such a way that in the event of a temperature change a change—produced by means of the temperature change—in a pressure exerted on the sensor membrane is minimized. By virtue of targeted structurings of the glob top, it is possible to further reduce the influence of a temperature acting externally on the sensor.

In a further embodiment, the glob top of the sensor has structurings, wherein the structurings of the glob top are embodied as crater-shaped and/or lamellar indentations. These structurings of the glob top in the geometrical embodiment mentioned are particularly advantageous for minimizing a temperature influence on the sensor.

In one embodiment, the glob top of the sensor includes silicone and/or silicone rubbers. Silicone or silicone rubbers, on account of their material properties, are particularly suitable for transmitting ambient pressure to a membrane of the sensor and at the same time protecting the membrane of the sensor.

In one embodiment, the glob top of the sensor furthermore at least partly has a protective layer at its surface. By means of the protective layer, the surface of the glob top and thus the sensor can be protected against external influences.

In one embodiment, the protective layer of the sensor includes parylenes. Parylenes are hydrophobic, chemically resistant plastics having a good barrier effect relative to inorganic and organic media, strong acids, alkaline solutions, gases and water vapor. Consequently, they are particularly suitable as a protective layer.

In one embodiment, the sensor includes a protective layer, wherein the protective layer is produced by means of a cold deposition process. In cold deposition processes, the innovative dry method uses a cold-active atmospheric pressure plasma generator and application-optimized micro- and/or nanopowders. In comparison with conventional metallization and coating methods, this not only saves numerous process steps, but the coating is also effected without solvents, in an energy-saving manner and in an environmentally compatible manner.

In one embodiment, the structurings of the glob top of the sensor are produced by means of a laser, and the wavelength of the light emitted by the laser advantageously lies in the short-wave UV range, that is to say in particular in the wavelength range between 100 and 400 nm. In this range, the wavelength of the light emitted by the laser lies in the absorption range of the glob top including silicone. As a result, the glob top can be structured particularly simply.

In one embodiment, the sensor includes structurings, wherein the structurings of the glob top are produced and are adjustable by means of a frame-shaped structure arranged around the sensor membrane. In this case, the structuring of the glob top is achieved during the application (dispensing) onto the sensor and the structure arranged in a frame-shaped manner. The sensors produced in this way can be realized particularly simply and cost-effectively.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 shows a sensor including membrane and glob top;

FIG. 2A shows a sensor including membrane and glob top at constant ambient pressure. The membrane curves convexly at a low temperature;

FIG. 2B shows a sensor including membrane and glob top at constant ambient pressure. The membrane does not curve or curves only very weakly at a medium temperature;

FIG. 2C shows a sensor including membrane and glob top at constant ambient pressure. The membrane curves concavely at a high temperature;

FIG. 3 shows an erroneous pressure produced by different temperatures. Pressure lines having distinctly different profiles depending on the temperature can be seen;

FIG. 4A shows a sensor including glob top on a membrane, wherein the glob top has structurings, for example a u-shaped cutout;

FIG. 4B shows a sensor including glob top on a membrane and including frame-shaped structures, wherein the glob top has a u-shaped cutout; and

FIG. 5 shows an erroneous pressure produced by different temperatures. Pressure lines having profiles that are scarcely distinguishable any longer depending on the temperature can be seen.

### DETAILED DESCRIPTION

Exemplary embodiments of the disclosure are explained in greater detail below, with reference to the accompanying figures. However, the disclosure is not restricted to the embodiments specifically described, but rather can be modified and altered in a suitable manner. It lies within the scope of the disclosure to suitably combine individual features and feature combinations of one embodiment with features and feature combinations of anther embodiment in order to arrive at further embodiments according to the disclosure.

Before the exemplary embodiments of the present disclosure are explained in greater detail below with reference to the figures, it is pointed out that identical elements in the figures are provided with the same or similar reference signs, and that a repeated description of said elements is omitted. Furthermore, the figures are not necessarily true to scale. Rather, the main emphasis is on elucidating the basic principle.

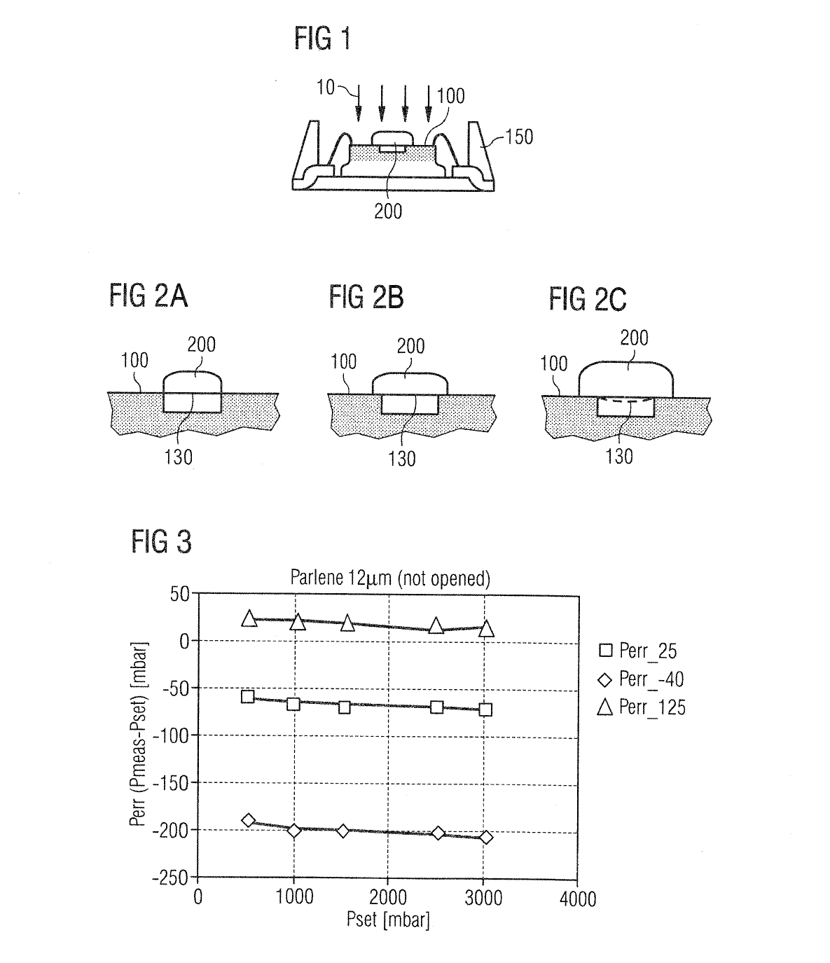

FIG. 1 shows a sensor 100 including a glob top 200 and a lateral coating. An external ambient pressure 10 acts on the sensor in the arrow direction, such that a pressure can be measured by the sensor 100. The term glob top generally denotes a coating which is used in particular during chip-on-board assembly. In this case, the glob top consists of a drop of resin which is applied over a semiconductor component or other electronic components. The resin serves to supply mechanical support for the electrical components and/or to protect them against external influences. In this present embodiment of a sensor including glob top, in particular silicone rubber or silicone can be used here. Silicone rubbers protect, for example, against thermal stress on the fragile components. The coating or protective lacquering of printed circuit boards or hybrid components with silicone rubber reliably protects assemblies against mechanical and chemical influences. Selected thermally conductive silicone rubber adhesive and sealant types make it possible, over and above the high damping of oscillations and the uniform distribution of stress between different materials, also to dissipate the heat that arises as a result of the operation of the component.

FIG. 2A shows a sensor 100 including glob top and a membrane 130. The membrane 130 curves convexly. The membrane 130 curves even though the ambient pressure is constant, but a temperature of -40° C. has the effect that the glob top exerts a pressure, which can also be designated as error pressure, on the membrane 130. This is not desired. Ideally, an ambient pressure should be able to be determined independently of the temperature.

FIG. 2B shows a sensor 100 including glob top 200 and a membrane 130. The membrane 130 scarcely curves. The membrane 130 scarcely curves since the temperature is 25° in this case. The erroneous pressure exerted by the glob top on the membrane 130 of the sensor 100 is low at this temperature.

FIG. 2C shows a sensor 100 including glob top 200 and a membrane 130. The membrane 130 curves concavely. The membrane 130 curves even though the ambient pressure is constant, but a temperature of 125° C. has the effect that the glob top exerts an erroneous pressure on the membrane 130. The pressure measured by the sensor in FIGS. 2A, 2B and 2C is therefore corrupted depending on the temperature at a constant ambient pressure.

FIG. 3 shows an erroneous pressure produced by different temperatures, namely −40° C., 25° C. and 125° C. Pressure lines having distinctly different profiles depending on the temperature can be seen. The erroneous pressure arises, as described in FIGS. 2A, 2B, 2C, since the glob top 200, depending on the temperature, but at constant ambient pressure, exerts a pressure on the membrane 130, and the sensor thus indicates an incorrect ambient pressure.

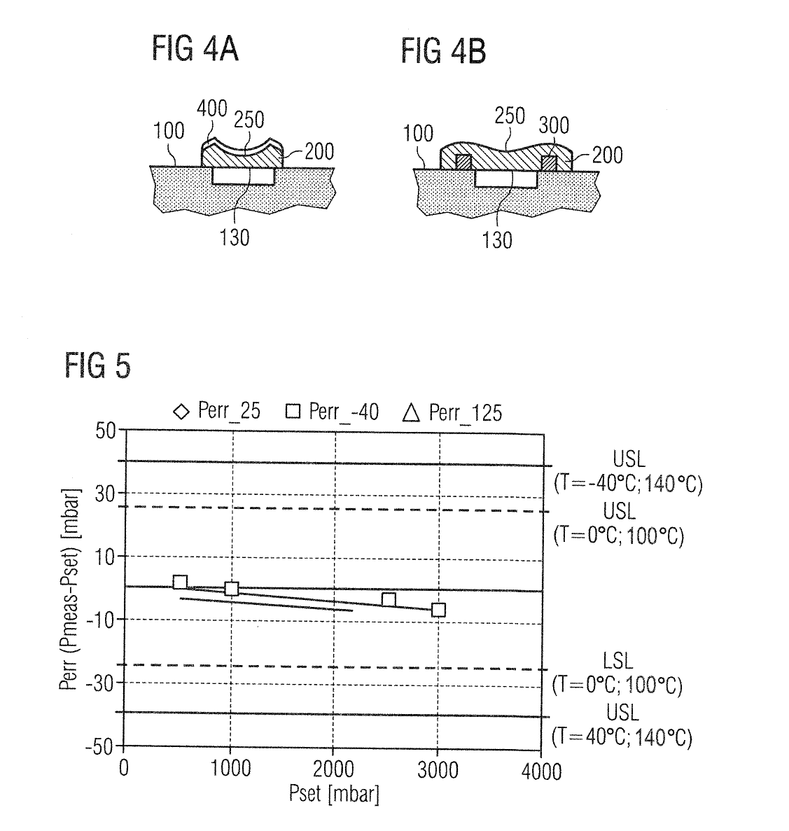

FIG. 4A shows a glob top 200 of a pressure sensor 100. The glob top is provided with structurings 250. In FIG. 4A shown, the structurings are embodied in a U-shaped fashion. However, the structurings can also assume any other arbitrary form, for example grooved, v-shaped, rectangular, hemispherical, crater-shaped, etc. The structurings can be produced by means of a laser. Ideally, the wavelength of the laser light is in this case coordinated with the absorption band of the material of the glob top 200. In this case, the glob top includes silicone, or silicone rubber. Ideally, the wavelength of the laser light would then be set in the short-wave UV range, that is to say between 100 and 400 nm. By virtue of the structuring 250 of the glob top shown, the influence of an external temperature on the pressure sensor can thus be demonstrably minimized, and a temperature-independent accurate measurement of the ambient pressure is thus possible and reproducible. In this respect, also see FIG 5. Furthermore, a protective layer 400 can additionally be applied to the glob top 200. The protective layer can extend completely or only partly over the glob top 200, or else beyond the glob top 200 over the entire sensor, and even over further adjacent electronic components. The protective layer may advantageously include chemically resistant polymer films, for example parylenes. Parylenes are hydrophobic, chemically resistant plastics having a good barrier effect relative to inorganic and organic media, strong acids, alkaline solutions, gases and water vapor. As a thin and transparent coating having high gap penetration, it is suitable for substrates of complex configuration including on edges. Furthermore, they have good electrical insulation properties with high dielectric strength and low relative permittivity. Consequently, they are particularly advantageous as an additional protective layer on the glob top.

FIG. 4B shows, like FIG. 4A, a glob top 200 of a pressure sensor 100. The glob top 200 is provided with structurings 250. In FIG. 4B shown, the structurings are embodied in a U-shaped fashion. However, the structurings can also assume any other arbitrary form, for example grooves, v-shaped, rectangular, hemispherical, crater-shaped, etc. In this embodiment of a pressure sensor, the pressure sensor furthermore includes a frame-shaped structure 300 arranged around the sensor. The shaping of the glob top 200, which is applied by dispensing, for example, is achieved as a result of the chosen arrangement of the frame-shaped structure 300. The material “flows” as it were into the desired form governed by the frame-shaped structure 300. After, the glob top 200 can likewise be provided with a further protective layer 400.

FIG. 5 shows an erroneous pressure produced by different temperatures. Lines having profiles that are scarcely distinguishable any longer can be seen, said lines showing the pressure profile depending on the temperature. Three lines are likewise illustrated here, showing the erroneous pressure produced at different temperatures, namely −40° C., 25° C. and 125° C. Pressure lines having profiles that are scarcely different any longer depending on the temperature can be seen. The erroneous pressure arises, as described in FIGS. 2A, 2B, 2C, since the glob top 200, depending on the temperature, but at a constant ambient pressure, exerts a pressure on the membrane 130, and the sensor thus indicates an incorrect ambient pressure. The temperature influence on the sensor 100 is thus minimized by means of the structurings 250 of the glob top 200.

For all described embodiments of a pressure sensor, however, it holds true that the disclosure is in no way restricted to pressure sensors, but rather encompasses any type of sensors, in particular MEMS sensors.

While the disclosure has been particularly shown and described with reference to specific embodiments, it should be understood by those skilled in the art that various changes in form and detail may be made therein without departing from the spirit and scope of the disclosure as defined by the appended claims and all changes which come within the meaning and range of equivalency of the claims are therefore intended to be embraced.

1. A sensor comprising a sensor membrane, wherein one side of the sensor membrane at least partly has a glob top and wherein the glob top has structurings.

2. The sensor as claimed in claim 1, wherein the structurings of the glob top are embodied in such a way that in the event of a temperature change a related change produced by means of the temperature change in a pressure exerted on the sensor membrane is minimized.

3. The sensor as claimed in claim 1, wherein the structurings of the glob top are embodied as crater-shaped and/or lamellar indentations.

4. The sensor as claimed in claim 1, wherein the glob top comprises silicone and/or silicone rubbers.

5. The sensor as claimed in claim 1, wherein the glob top furthermore at least partly has a protective layer at its surface.

6. The sensor as claimed in claim 5, wherein the protective layer comprises parylenes.

7. The sensor as claimed in claim 5, wherein the protective layer is produced by means of a cold deposition process.

8. The sensor as claimed in claim 1, wherein the structurings of the glob top are produced by means of a laser, and wherein the wavelength of light emitted by the laser lies in the short-wave UV range.

9. The sensor as claimed in claim 1, wherein the structurings of the glob top are adjustable by means of a frame-shaped structure arranged around the sensor membrane.
